(19) United States
(12) Patent Application Publication
(10) Pub. No.: US 2015/0106701 A1
(43) Pub. Date: Apr. 16, 2015

(54) INPUT SUPPORT METHOD AND INFORMATION PROCESSING SYSTEM

(71) Applicant: FUJITSU LIMITED, Kawasaki-shi (JP)

(72) Inventors: Haruhito Honma, Kawasaki (JP); Kiyofumi Osanai, Itabashi (JP); SHOUJI IWAMOTO, Yamato (JP)

(21) Appl. No.: 14/573,662

(22) Filed: Dec. 17, 2014

Related U.S. Application Data
(63) Continuation of application No. PCT/JP2012/067154, filed on Jul. 5, 2012.

(51) Int. Cl. G06F 17/22

(52) U.S. Cl. CPC G06F 17/2276
USPC 715/259

(57) ABSTRACT

A terminal transmits, to a management apparatus, item information indicating an item name of an input field displayed on a display unit. The management apparatus selects a dictionary corresponding to the received item information amongst a plurality of dictionaries each including a plurality of data options and classified based on a predetermined condition. The management apparatus transmits, to the terminal, at least one data option corresponding to the item information, obtained based on the selected dictionary.

### CROSS-REFERENCE TO RELATED APPLICATION

This application is a continuation application of International Application PCT/JP2012/067154 filed on Jul. 5, 2012 which designated the U.S., the entire contents of which are incorporated herein by reference.

### FIELD

The embodiments discussed herein are related to an input support method and an information processing system.

### BACKGROUND

Information processing systems are currently in use which store, in a database, data entered on the screen of a terminal device and allow searching the database later for the data. One application of such an information processing system is, for example, that a terminal device, such as a personal computer, transmits input data to a server apparatus, such as a Web server, via a network and the server apparatus stores, in a database, the input data received from the terminal. An input screen displayed on the terminal device may be defined by screen information, such as a HyperText Markup Language (HTML) document, provided by the Web server, or may be defined by application software installed on the terminal device.

Note here that data stored in the database is preferably presented in a unified notation so as to facilitate efficient search and compiling. For example, in the case where several different notations, such as a formal name and an abbreviated name, are used to represent some addresses and company names, it is preferable that each of such addresses and company names be not registered in a database under different notations. If data in different notations is present, it is difficult to thoroughly search for data practically representing the same content by simple matching processing, which may interfere with effective use of data. On the other hand, notation inconsistencies tend to take place in an information processing system where a plurality of users enter data.

In view of the above-described problem, a process called data cleansing is used in order to eliminate the mixture of data in different notations in a database. In the data cleansing process, rules of correspondence between data pieces whose notations need to be corrected and correction methods of the data pieces are predefined. Then, according to the rules, each correction target data piece is searched for in the database and automatically corrected. Note however that, in the data cleansing process, a computer is not always able to uniquely identify corrected notations for all correction target data pieces stored in the database, and thus it is not easy to correct data pieces to be automatically 100%. As for a data piece failed to be automatically corrected by the computer, an administrator of the information processing system may ask a user who has entered the data piece about his/her purpose in entering the data piece.

Note that a system has been proposed in which a Web server transmits document data with an identifier indicating the type of text input field, then a character input support apparatus embeds dictionary information corresponding to the identifier in the document data, and a user terminal displays conversion options for an input character with reference to the embedded dictionary information. In addition, another proposed system is to recognize a character string on an image using an optical character reader (OCR), and correct the recognized character string into an appropriate word by checking it against, amongst a plurality of types of dictionary data, dictionary data of a type designated by a specific category name.

Japanese Laid-open Patent Publication No. 2009-20865

Japanese Laid-open Patent Publication No. 2003-187188

Because data cleansing does not always achieve automatic correction with 100% accuracy, as described above, data with notation inconsistencies may be stored in a database. In that case, it is not easy to resolve the lack of consistency later. Therefore, an information processing system preferably provides support in such a manner that data in a unified notation be entered prior to the storage of the data in the database. One possible approach may be to prepare an input screen allowing the user to select a character string from a list, instead of allowing the user to input a free-form character string, so as to prevent the user from entering data other than data in a predetermined notation. However, as for existing information processing systems, it is not always the case that modifications are able to be made to the input screen or the program of a server apparatus, and it is thus difficult to add an input support function to such existing information processing systems.

### SUMMARY

According to one embodiment, there is provided an input support method executed by a system including a terminal provided with a display unit and a management apparatus accessible from the terminal. The input support method includes transmitting, from the terminal to the management apparatus, item information indicating an item name of an input field displayed on the display unit; selecting, by a processor, a dictionary corresponding to the item information received by the management apparatus amongst a plurality of dictionaries each including a plurality of data options and classified based on a predetermined condition; and transmitting, from the management apparatus to the terminal, at least one data option corresponding to the item information, obtained based on the selected dictionary.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing system according to a first embodiment;

FIG. 2 illustrates an information processing system according to a second embodiment;

FIG. 3 illustrates an example of a window including input items;

FIG. 4 illustrates an example of input support on the window;

FIG. 5 is a block diagram illustrating an example of hardware of a client device;

FIG. 6 is a block diagram illustrating an example of functions of the client device and servers;

FIG. 7 illustrates an example of a window identification table;

FIG. 8 illustrates an example of a data type table;

FIG. 9 illustrates an example of a button table;

FIG. 10 illustrates an example of a control method table;

FIG. 11 illustrates an example of an input item table;

FIG. 12 illustrates an example of a confirmation button table;

FIG. 13 is a sequence diagram illustrating an example of communication between the client device and a server;

FIG. 14 is a flowchart illustrating an example of procedures for identification information extraction and control method determination;

FIG. 15 is a flowchart illustrating an example of procedures for input item identification;

FIG. 16 is a flowchart illustrating an example of procedures for data type determination;

FIG. 17 is a flowchart illustrating an example of procedures for button identification;

FIG. 18 is a flowchart illustrating an example of procedures for confirmation button determination;

FIG. 19 is a flowchart illustrating an example of procedures for input control;

FIG. 20 is a flowchart illustrating an example of procedures for option determination;

FIG. 21 is a flowchart illustrating an example of procedures for examination and correction control; and

FIG. 22 is a flowchart illustrating an example of procedures for examination and correction determination.

### DESCRIPTION OF EMBODIMENTS

Several embodiments will be described below with reference to the accompanying drawings, wherein like reference numerals refer to like elements throughout.

### (a) First Embodiment

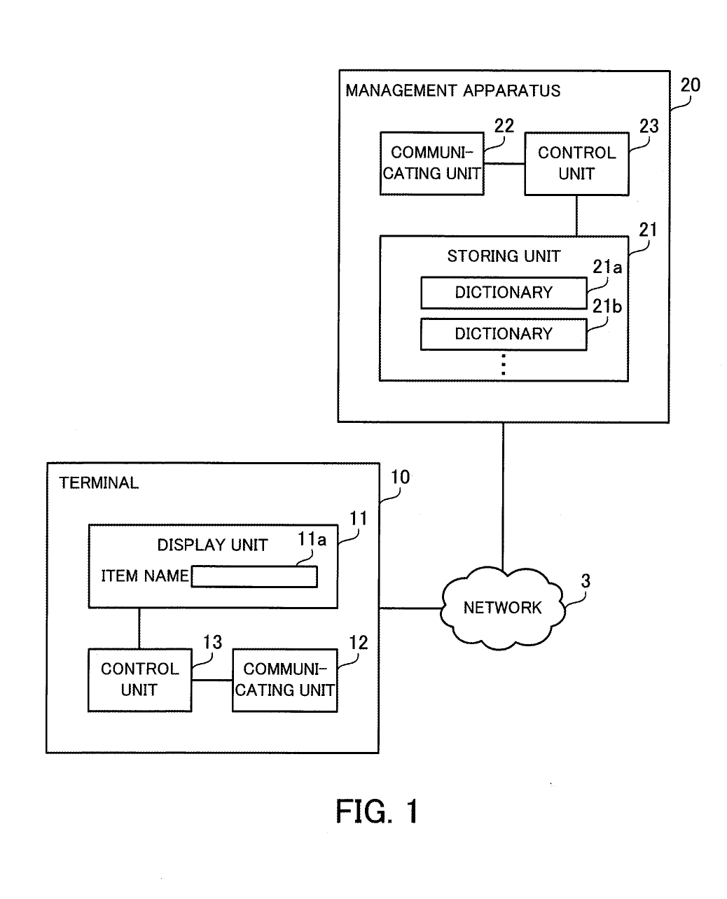

FIG. 1 illustrates an information processing system according to a first embodiment. The information processing system of the first embodiment includes a terminal 10 and a management apparatus 20, which are connected via a network 3. For example, the terminal 10 is a client computer operated by a user, and the management apparatus 20 is a server computer accessed from the terminal 10. The network 3 may be a local area network (LAN) or a broad area network such as the Internet.

The terminal 10 includes a display unit 11, a communicating unit 12, and a control unit 13. The display unit 11 displays an input screen. The input screen may be defined by application software installed on the terminal 10, or may be drawn by a Web browser based on screen information, for example, an HTML document, provided by the management apparatus 20 or a different server. The input screen includes an input field 11a, to which the user is allowed to enter data such as a character string. Near the input field 11a, the item name of the input field 11a may be displayed.

The communicating unit 12 communicates with the management apparatus 20 and a different server via the network 3. The communicating unit 12 accesses and performs data communication with the management apparatus 20 and the different server using a protocol, such as the Transmission Control Protocol/Internet Protocol (TCP/IP) or the Hypertext Transfer Protocol (HTTP).

The control unit 13 provides support in entering data in the input field 11a, in cooperation with the management apparatus 20. The control unit 13 includes, for example, at least one processor and memory. The processor may be a central processing unit (CPU) or a digital signal processor (DSP). In addition, the processor may include an electronic circuit, such as an application specific integrated circuit (ASIC) or a field programmable gate array (FPGA). The memory may be random access memory (RAM). The following functions are implemented, for example, when the processor executes a program stored in the memory.

The management apparatus 20 includes a storing unit 21, a communicating unit 22, and a control unit 23. The storing unit 21 stores a plurality of dictionaries including dictionaries 21a and 21b. Each of the dictionaries includes a plurality of data options. The dictionaries are created, for example, by classifying data options according to the data type. The storing unit may be a volatile memory such as RAM, or a non-volatile memory such as a hard disk drive (HDD) or a flash memory. The communicating unit 22 communicates with the terminal 10 via the network 3. The communicating unit 22 accepts access from the terminal 10 and performs data communication with the terminal 10 according a protocol, such as the TCP/IP or HTTP.

The control unit 23 provides support to the user of the terminal 10 in entering appropriate data in the input field 11a, using the dictionaries stored in the storing unit 21. The control unit 23 includes, for example, at least one processor and memory. As in the case above, the processor may be a CPU or DSP, and may include an electronic circuit, such as an ASIC or FPGA. The memory may be RAM, or may be a part of the storing unit 21. The following functions are implemented, for example, when the processor executes a program stored in the memory.

The information processing system according to the first embodiment provides support in entering data into the input field 11a in the following manner. The terminal 10 transmits item information indicating an item name of the input field 11a to the management apparatus 20 via the network 3. The item name may be obtained by extracting one displayed near the input field 11a, or by extracting one from invisible information, such as a tag, included in screen information, such as an HTML document. The item information may be transmitted either before or after the input field 11a is displayed in the display unit 11.

The management apparatus 20 selects, amongst the plurality of dictionaries stored in the storing unit 21, a dictionary corresponding to the item information received from the terminal 10. For example, the management apparatus 20 estimates the data type of data to be entered in the input field 11a based on the item name indicated by the item information, and selects a dictionary corresponding to the estimated data type. Subsequently, the management apparatus 20 obtains, based on the selected dictionary, one or more options of data corresponding to the item information and to be entered in the input field 11a and transmits the data options to the terminal 10 via the network 3. Note here that only one data option, or a plurality of data options, may be transmitted to the terminal 10.

Based on the data options received from the management apparatus 20, the terminal 10 provides support to the user in entering data in the input field 11a. For example, the terminal 10 displays the received data options near the input field 11a so that the user is able to select one of the options. If there is only one data option received, the terminal 10 may embed the data option in the input field 11a without user operation. Once the input data for the input field 11a is confirmed based on the data options, the terminal 10 transmits the determined input data to a server (the management apparatus 20 or a different server) via the network 3. Upon receiving the input data, the server stores the input data in a database.

Note that the item information may be transmitted from the terminal 10 to the management apparatus 20 when the input field 11a is displayed in the display unit 11, and the data options may be transmitted from the management apparatus 20 to the terminal 10 in response to user operation of the input field 11a. In this case, after detecting the user operation, the terminal 10 may transmit data entered up to this point to the management apparatus 20, and based on the data entered up to this point, the management apparatus 20 may transmit final or corrected data options to the terminal 10. The detected user operation here means, for example, input operation made to the input field 11a or button operation to confirm data entered thereto.

The information processing system of the first embodiment provides support in entering appropriate data in the input field 11a prior to storing data in a database, thereby preventing inconsistent data from being stored in the database. In addition, the terminal 10 transmits item information indicating an item name of the input field 11a to the management apparatus 20, which in turn transmits, to the terminal 10, data options obtained based on a dictionary corresponding to the item information. Therefore, it is possible to present appropriate data options without the need for modifying the definition of an input screen or altering the program of a server for updating a database in an existing information processing system. In this manner, the input support function is easily added to the information processing system.

Note that the input support function of the terminal 10 may be implemented as a plug-in incorporated in a Web browser, or as character input assistant software (an example of such is what is termed “input method editor (IME))”. For example, Japanese character input assistant software provides conversions from alphabets to kana characters (Japanese phonetic characters) and conversions from kana characters to kanji characters (Chinese characters used in Japanese language). A second embodiment below uses character input assistant software.

### (b) Second Embodiment

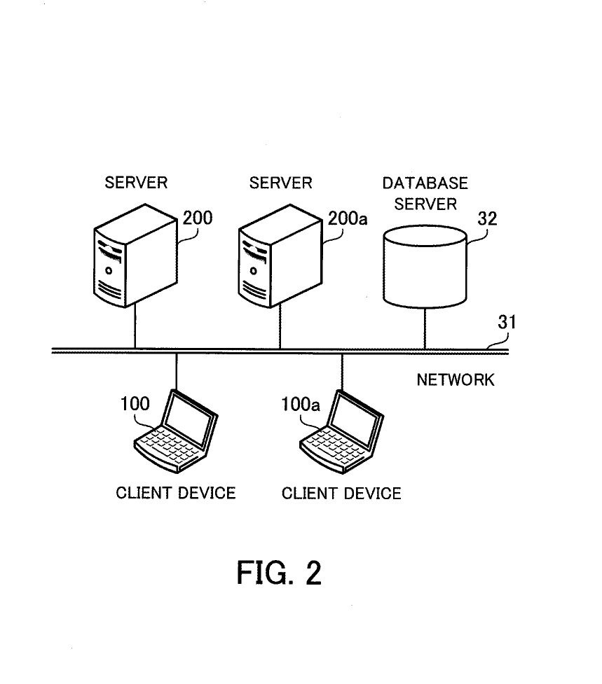

FIG. 2 illustrates an information processing system according to the second embodiment. The information processing system of the second embodiment includes a network 31, a database server 32, client devices 100 and 100a, and servers 200 and 200a. The database server 32, the client devices 100 and 100a, and the servers 200 and 200a are connected to the network 31.

The database server 32 is a server computer for storing data in non-volatile memory, such as a HDD, provided in the database server 32 and managing a collection of data as a database. The database server 32 receives a data write request from the server apparatus 200a via the network 31, and stores data associated with the data write request. The database is likely to be subject to data processing, such as search for data including a value designated by a user and compilation of data including the same value. In view of this, it is preferable that data stored in the database server 32 be presented in a unified notation in order to facilitate data search and compilation. For example, in the case where several different notations are used to represent addresses and company names, it is desirable that data pieces with the same address or company name represented in different notations do not exist in the database so as to prevent retrieval omission. According to the second embodiment, the client devices 100 and 100a and the server 200 cause data to be represented in a unified notation in cooperation with each other before the data is transmitted from the server 200a to the database server 32 and then added to the database.

The client devices 100 and 100a are client computers, or terminals, operated by users. Each of the client devices 100 and 100a displays an input screen including an input field to receive a character entry made by the user in the input field, and transmits, to the server 200a, a character string confirmed as data to be stored in the database server 32. The input screen may be a screen defined by application software installed on the client device 100/100a, or a screen drawn by a Web browser based on an HTML document downloaded from the server 200a.

In addition, character input assistant software has been installed on the client devices 100 and 100a. In the case of inputting Japanese language, the character input assistant software converts alphabets designated by key inputs into kana characters, and then converts the kana characters into kanji characters in response to a conversion command. Further, the installed character input assistant software provides support in inputting a character string complying with a predetermined notation in the input field, in cooperation with the server 200. The input support is provided, for example, by displaying character string options presented by the server 200 near the input field or by replacing the character string currently entered in the input field with an option of the presented character strings.

The server 200 is a server computer accessed from the client devices 100 and 100a. The server 200 provides support to the user in inputting characters in the input field, in cooperation with the character input assistant software installed on the client device 100/100a. The server 200 receives a pre-confirmed character string currently entered from the client device 100/100a. Subsequently, based on the received character string, the server 200 searches a dictionary for character string options corrected in accordance with a predetermined notation, and transmits the options to the client device 100/100a. In the case of inputting Japanese language, characters transmitted from the client device 100/100a to the server 200 may be kana or kanji characters. The corrected character string options may be presented, for example, in response to an input entered in the input field or immediately before a character string is confirmed as data to be stored in the database server 32.

The server 200a is a server computer accessed from the individual client devices 100 and 100a. The server 200a receives data, which is a confirmed character string, from the client device 100/100a via the network 31, and then transmits, to the database server 32, a write instruction to write the received data in the database. The server 200a may be a Web server, and in that case, the server 200a may transmit an HTML document defining an input screen with an input field to the client device 100/100a in response to an access from the client device 100/100a.

Note that the client devices 100 and 100a are examples of the terminal 10 of the first embodiment. The server 200 is an example of the management apparatus 20 of the first embodiment, and the network 31 is an example of the network 3 of the first embodiment. According to the second embodiment, the server 200 provides support in data input taking place in the client device 100/100a while the server 200a updates the database; however, a single server may carry out processes of both the servers 200 and 200a, described below.

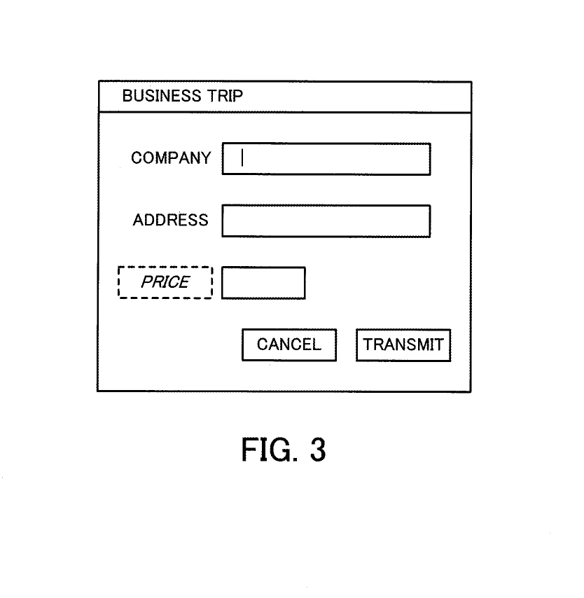

FIG. 3 illustrates an example of a window including input items. A window like one illustrated in FIG. 3 is displayed on each of the client devices 100 and 100a. The window of FIG. 3 includes three input fields, three labels each corresponding to one of the input fields, and two buttons. To the first input field, an item name of “company” is given, and a character string representing a company name is expected to be entered by the user. To the second input field, an item name of “address” is given, and a character string representing an address is expected to be entered by the user. To the third input field, an item name of “price” is given, and a numerical value representing price is expected to be entered by the user. A label indicating the item name of each input field is displayed to the left of the input field. The first and second labels are displayed as text, and the third label is displayed as an image.

Two buttons are provided below the three input fields. The left button is a button with a name of “CANCEL”, which is pressed by the user to cancel an input operation. The right button is a button with a name of “TRANSMIT”, which is pressed by the user to confirm character strings entered in the three input fields and transmit the character strings to the server 200a from the client device 100/100a. Various terms are given to buttons having the same functions as the CANCEL button and the TRANSMIT button of FIG. 3, depending on windows. In the following description, buttons having the same function as the TRANSMIT button of FIG. 3 are collectively called “confirmation button”.

The label representing the item name of each input field is often located to the left of or above the input field. In addition, the confirmation button is often located in the bottom, rightmost corner of the window. The client devices 100 and 100a and the server 200 use this placing arrangement of the display parts in order to allow an input operation in each input field and a selection operation on the confirmation button to be detected. Note that the locations of the display parts, including the input fields, the labels, and the buttons, are defined by a coordinate system with the origin being in the upper left corner of the window. Coordinates of the top-left corner of each display part, for example, are used to represent the location of the display part.

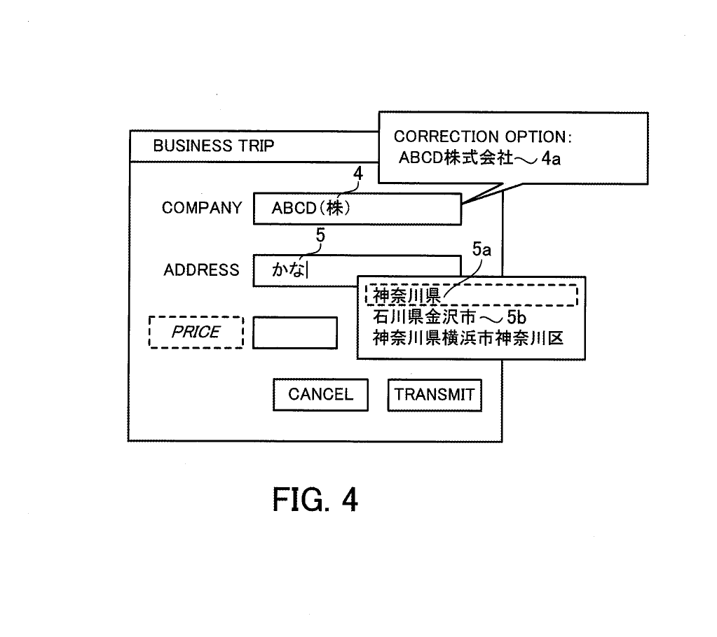

FIG. 4 illustrates an example of input support on a window. There are three possible timings for character string options allowed to be entered in an input field to be presented by the server 200: (1) during characters (which may be kana characters before conversion in the case of inputting Japanese language) being entered in the input field; (2) when the focus is shifted from an input field in which a character string has been entered to a different input field; and (3) when a confirmation button is pressed.

(1) During characters being entered in an input field, characters entered up to this point in time are transmitted from the client device 100/100a to the server 200. Then, the server 200 transmits, to the client device 100/100a, character string options complying with a predetermined notation, including the characters or other characters converted from the characters (for example, kanji characters converted from kana characters), and the character string options are presented on the client device 100/100a. The user is allowed to select one of the character string options displayed near the input field. For example, when the user has entered a kana character string 5 in the input field with the item name “address”, character strings 5a, 5b, and so on are displayed as character string options representing addresses. Note that the character string options may be displayed in response to a conversion command given by the user instead.

(2) When the focus is shifted away from an input field in which a character string has been entered (i.e., the user has moved the focus away from the input field, and this operation is hereinafter referred to as “focus-away operation”), the character string entered in the input field is transmitted from the client device 100/100a to the server 200. Then, if the server 200 determines that the character string is not in conformity with a predetermined notation, the server 200 transmits, to the client device 100/100a, a corrected character string option, which is then presented on the client device 100/100a. The corrected character string option may be displayed near the input field so as to prompt the user to make a correction. Alternatively, the corrected character string option may be displayed in the input field after replacing the original character string entered therein. For example, when the user enters an abbreviated name 4 of a company in the input field with the item name “company”, a formal name 4a of the company is displayed as its corrected character string option.

(3) The procedure to update the database is interrupted when the confirmation button is pressed, and a character string entered in each input field of the window is examined and, then, a corrected character string may be displayed for the input field in a manner similar to the input support function (2) above. Either one or both of the input support functions (2) and (3) may be set not to operate. Note that the input support functions (2) and (3) correct each character string to comply with a predetermined notation before the character string is stored in the database, and this correction is also referred to as “cleansing” in the second embodiment.

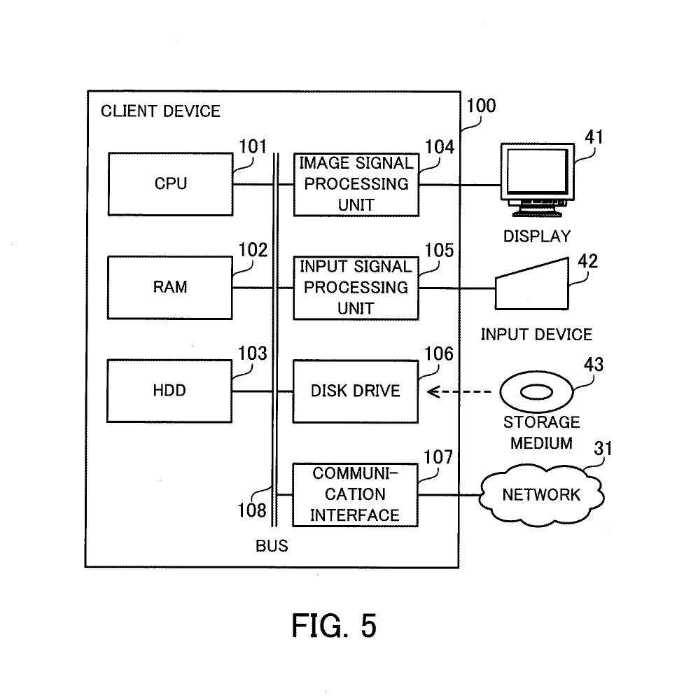

FIG. 5 illustrates is a block diagram illustrating an example of hardware of the client device. The client device 100 includes a CPU 101, RAM 102, a HDD 103, an image signal processing unit 104, an input signal processing unit 105, a disk drive 106, and a communication interface 107. These individual units of the client device 100 are connected to a bus 108.

The CPU 101 is a processor including a computing unit for carrying out program instructions. The CPU 101 loads at least part of a program and data stored in the HDD 103 into the RAM 102 to execute the program. Note that the CPU 101 may include a plurality of processor cores and the client device 100 may include a plurality of processors, and processes described later may be executed in parallel using the plurality of processors or processor cores. In addition, a set of two or more processors, a dedicated circuit such as a FPGA or ASIC, a set of two or more dedicated circuits, or a combination of a processor and a dedicated circuit may be referred to as a “processor”.

The RAM 102 is a volatile memory for temporarily storing therein programs to be executed by the CPU 101 and data to be referred to during the execution of the program. Note that the client device 100 may be provided with a different type of memory other than RAM, or may be provided with a plurality of volatile memory devices. The HDD 103 is a nonvolatile memory device to store therein software programs, such as an operating system (OS), firmware, and application software, and various types of data. Note that the client device 100 may be provided with a different type of storage device, such as a flash memory or a solid state drive (SDD), or may be provided with a plurality of non-volatile memory devices.

The image signal processing unit 104 outputs an image on a display 41 connected to the client device 100 according to an instruction from the CPU 101. A cathode ray tube (CRT) display or a liquid crystal display, for example, may be used as the display 41. Note that the display 41 connected to the client device 100 may be provided as a component of the client device 100 instead. Alternatively, the display 41 may be integrally provided on the chassis of the client device 100. The input signal processing unit 105 acquires an input signal from an input device 42 connected to the client device 100 and sends the input signal to the CPU 101. A pointing device, such as a mouse or touch panel, or a keyboard, for example, may be used as the input device 42. Note that the input device 42 connected to the client device 100 may be provided as a component of the client device 100 instead. Alternatively, the input device 42 may be integrally provided on the chassis of the client device 100.

The disk drive 106 is a drive unit for reading programs and data recorded on a storage medium 43. Examples of the storage medium 43 include a magnetic disk such as a flexible disk (FD) and a HDD, an optical disk such as a compact disc (CD) and a digital versatile disc (DVD), and a magneto-optical disk (MO). According to instructions of the CPU 101, the disk drive 106 stores the programs and data read from the storage medium 43 in the RAM 102 or the HDD 103. The communication interface 107 is a wire communication interface capable of carrying out data communication with the server 200 via the network 31. Note however that the communication interface 107 may be a wireless communication interface connected to an access point.

Note that the client device 100 may not be provided with the disk drive 106, and further may not be provided with the image signal processing unit 104 and the input signal processing unit 105 in the case where the client device 100 is accessible from a different computer operated by the user. The client device 100a, the servers 200 and 200a may individually have the same hardware configuration as the client device 100. Note that a combination of the CPU 101 and the RAM 102 is an example of the control unit 13 of the first embodiment. In addition, the communication interface 107 and the display 41 are examples of the communicating unit 12 and the display unit 11, respectively, of the first embodiment.

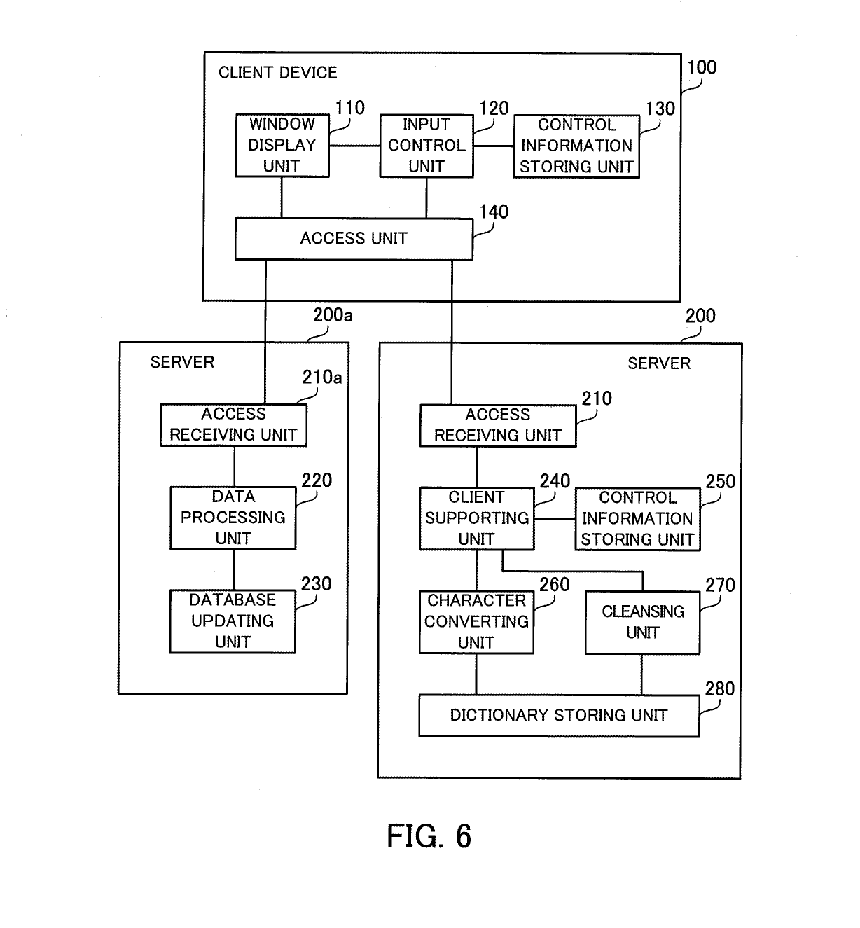

FIG. 6 is a block diagram illustrating an example of functions of the client device and servers. The client device 100 includes a window display unit 110, an input control unit 120, a control information storing unit 130, and an access unit 140. The control information storing unit 130 may be implemented as a storage area allocated in the RAM 102 or the HDD 103. The units other than the control information storing unit 130 may be implemented as modules of a program executed by the CPU 101. The client device 100a may have the same module configuration as the client device 100.

The window display unit 110 is a module corresponding to a process to display a window. In the case where the process is a Web browser, the window display unit 110 renders a Web page in the window based on an HTML document received from the server 200. In the case where the process is application software installed on the client device 100, the window display unit 110 draws display parts in the window using an application programming interface (API) of its operating system.

The input control unit 120 is a character input assistant software module and provides support to a user in character input. Upon the launch of a process corresponding to the window display unit 110 on the client device 100, the input control unit 120 is incorporated into the process and operates. When a window is displayed by the window display unit 110, the input control unit 120 acquires, from the server 200, control information indicating the type of input support to be provided for the window and stores the control information in the control information storing unit 130. Then, when detecting user operations on the window, the input control unit 120 acquires, from the server 200, one or more appropriate character string options to be entered in each input field according to the control information stored in the control information storing unit 130 and displays the character string options.

The control information storing unit 130 stores the control information referred to by the input control unit 120 to provide input support. The control information stored in the control information storing unit 130 includes information on windows, information on input fields, and information on confirmation buttons, as described later. The access unit 140 accesses the server 200/200a according to a request from the window display unit 110 or the input control unit 120. For example, upon the display of a window or the detection of a specific user operation on a window, the access unit 140 accesses the server 200 according to a request from the input control unit 120. In addition, when a character string entered in an input field is confirmed as data to be stored in the database, the access unit 140 transmits the data to the server 200a according to a request from the window display unit 110.

The server 200 includes an access receiving unit 210, a client supporting unit 240, a control information storing unit 250, a character converting unit 260, a cleansing unit 270, and a dictionary storing unit 280. The server 200a includes an access receiving unit 210a, a data processing unit 220, and a database updating unit 230. The dictionary storing unit 280 may be implemented as a storage area allocated in RAM or a HDD of the server 200a. The units other than the dictionary storing unit 280 may be implemented as modules of a program executed by a CPU.

The access receiving units 210 and 210a receive accesses from the client devices 100 and 100a. Upon receiving an access for input support prior to confirmation of input data, the access receiving unit 210 of the server 200 notifies the client supporting unit 240 of the access. When receiving confirmed input data, the access receiving unit 210a of the server 200a outputs the input data to the data processing unit 220.

The data processing unit 220 is a server software module corresponding to Web browsers or application software running on the client devices 100 and 100a. The data processing unit 220 carries out predetermined data processing, such as addition of a timestamp, on input data confirmed by the user, and outputs the resultant input data to the database updating unit 230. The database updating unit 230 generates a write instruction to cause the data received from the data processing unit 220 to be stored in the database, and transmits the write instruction to the database server 32.

The client supporting unit 240 provides the client device 100/100a with input support information in response to an access from the client device 100/100a. When a window is displayed on the client device 100/100a, the client supporting unit 240 searches the control information storing unit 250 for control information for controlling input operations on the window and provides the control information for the client device 100/100a. Upon receiving characters while entering (for example, kana characters before being converted into kanji characters), the client supporting unit 240 causes the character converting unit 260 to convert the characters to thereby provide the client device 100/100a with converted character string options. Upon receiving a character string having been entered in an input field, the client supporting unit 240 causes the cleansing unit 270 to cleanse the received character string, and provides the client device 100/100a with a corrected character string option if a correction needs to be made.

The control information storing unit 250 stores therein control information for providing support in character input on the client device 100/100a. The control information stored in the control information storing unit 250 includes information on windows, information on data types, and information on confirmation buttons, as described later.

The character converting unit 260 obtains one or more character string options in conformity with a predetermined notation based on characters being entered, by referring to a dictionary stored in the dictionary storing unit 280. In the case of inputting Japanese language, a kana-to-kanji conversion module may be used. For example, the character converting unit 260 converts kana characters being entered into kanji characters. In addition, using a predictive conversion function, the character converting unit 260 searches a dictionary for character strings each including the characters being entered or converted characters. Subsequently, the character converting unit 260 outputs the converted character string options to the client supporting unit 240.

The cleansing unit 270 cleanses a character string input by the user. That is, the cleansing unit 270 examines whether the input character string is in conformity with a predetermined notation, by referring to a dictionary stored in the dictionary storing unit 280. When the character string does not pass the examination, the cleansing unit 270 estimates a corrected character string option corresponding to the input character string by referring to the dictionary. Then, the cleansing unit 270 outputs the examination result, and the corrected character string option when the character string has failed the examination, to the client supporting unit 240.

The dictionary storing unit 280 stores therein dictionaries each corresponding to one of a plurality of data types. For example, an address-type dictionary in which addresses are presented in a predetermined, unified notation and a corporate-type dictionary in which corporate names are presented in a predetermined, unified notation are prepared in advance. Each dictionary includes a plurality of character string options possible to be provided to the client devices 100 and 100a. In the case of dealing with Japanese language input, each dictionary contains character string sets, each of which is composed of a character sting with kanji and a character string corresponding to Japanese phonetic syllabary characters of the kanji.

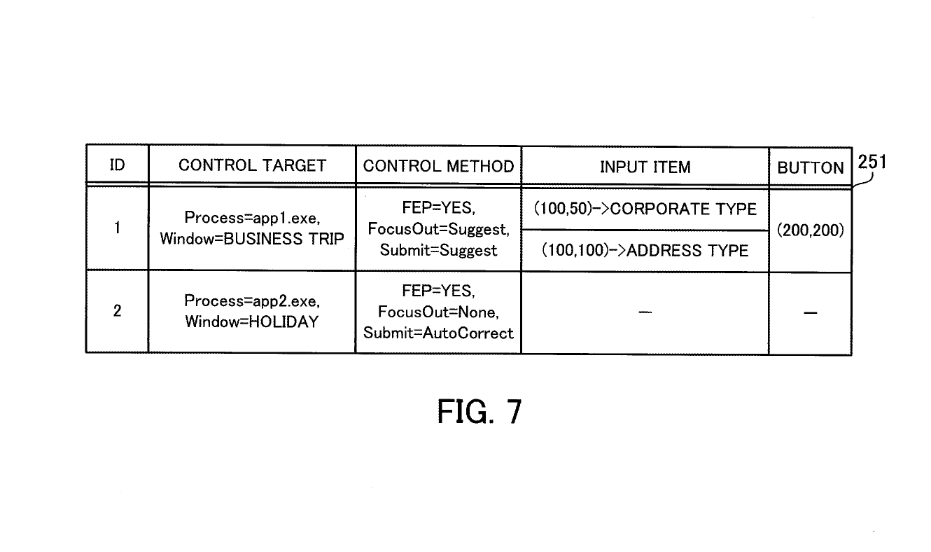

FIG. 7 illustrates an example of a window identification table. A window identification table 251 is stored in the control information storing unit 250. The contents of the window identification table 251 are defined, for example, by the user in advance. The window identification table 251 includes columns of identification (ID), control target, control method, input item, and button.

Each field in the identification column contains the identifier to identify a window (a Web page in the case of a Web browser) possible to be displayed on the client device 100/100a. Each field in the control target column contains the name of a process to display the corresponding window and the window name (the Web page name in the case of a Web browser). Each window is identified by a set of the process name and the window name. Each field in the control method column contains the flag indicating whether to run the input support function on the window (FEP); the operation to take place when the focus is shifted away (FocusOut); and the operation to take place when the confirmation button is pressed (Submit). Each operation to take place when the focus is shifted away and when the confirmation button is pressed is selected from the following choices: taking no action (None); displaying a character string option near the corresponding input field (Suggest); and automatically correcting the character string in the corresponding input field (AutoCorrect).

Each field in the input item column contains, when the location of one or more input fields is known in advance, the coordinates of each of the input fields and the data type of a character string to be entered. If there is no input field whose location is known, the corresponding field in the input item column may be left blank. Each field in the button column contains, when the location of a confirmation button is known in advance, the coordinates of the confirmation button. If the location of the confirmation button is not known, the field in the button column may be left blank.

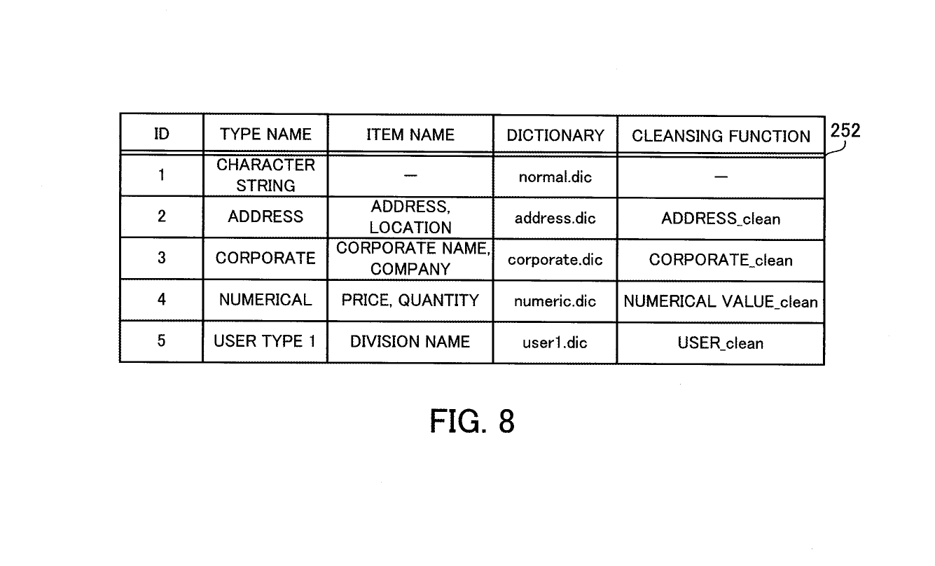

FIG. 8 illustrates an example of a data type table. A data type table 252 is stored in the control information storing unit 250. The contents of the data type table 252 are defined, for example, by the user in advance. The data type table 252 includes columns of identification (ID), type name, item name, dictionary, and cleansing function.

Each field in the identification column contains the identifier to identify a data type. Each field in the type name column contains the name of the corresponding data type, such as “address” type and “corporate” type. Note in FIG. 8 that “user type 1” is a data type customized by the user, and “character string” Type is a data type with a character string that does not fall under any other data type. Each field in the item name column contains one or more names possible to be used as input field labels. For example, for the type name “address”, character strings such as “address” and “location” are registered, and for the type name “corporate”, character strings such as “corporate name” and “company” are registered.

Each field in the dictionary column contains the name of a dictionary for the corresponding data type amongst a plurality of dictionaries stored in the dictionary storing unit 280. Each field in the cleansing function column contains, amongst a plurality of functions (cleansing functions) prepared in the cleansing unit 270, the name of a function to be called by the client supporting unit 240 to cleanse a character string of the corresponding data type. Note that in each cleansing function, the corresponding dictionary registered in the dictionary column is referred to.

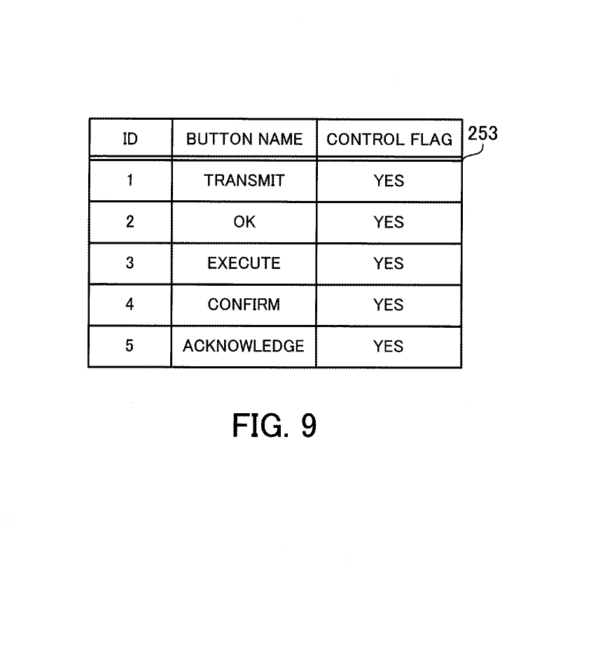

FIG. 9 illustrates an example of a button table. A button table 253 is stored in the control information storing unit 250. The contents of the button table 253 are defined, for example, by the user in advance. The button table 253 includes columns of identification (ID), button name, and control flag. Each field in the identification column contains the identifier to identify the name of a confirmation button. Each field in the button name column contains the name possible to be used as the label of a confirmation button, such as “transmit”, “OK”, or “execute”. Each field in the control flag column contains the flag indicating whether to conduct an examination and make a correction to a character string when a confirmation button with the corresponding label is pressed.

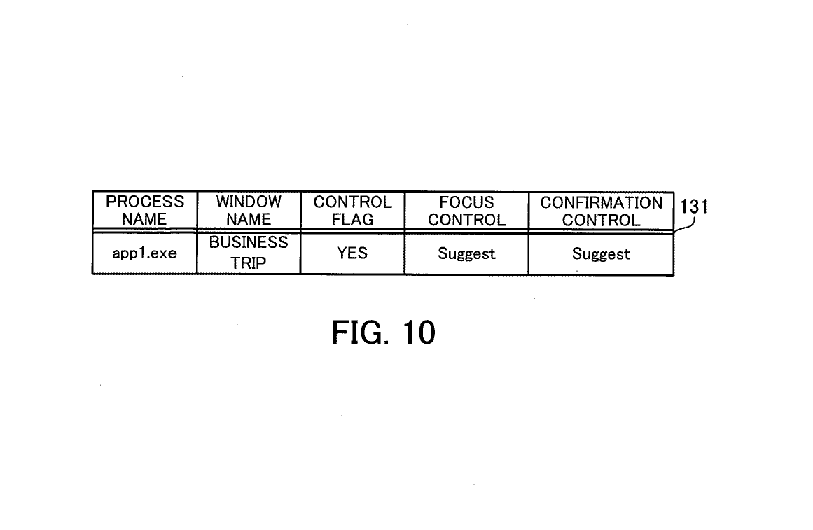

FIG. 10 illustrates an example of a control method table. A control method table 131 is stored in the control information storing unit 130. The control method table 131 is updated by the input control unit 120 through communication with the server 200. The control method table 131 includes columns of process name, window name, control flag, focus control, and confirmation control.

Each field in the process name column contains the name of a process to display a window. Each field in the window name column contains the name of a displayed window. Each field in the control flag column contains the flag indicating whether to provide input support, such as displaying character string options, for the corresponding window. Each field in the focus control column contains the operation to take place when the focus is shifted away from an input field on the corresponding window. Each field in the confirmation control column contains the operation to take place when the confirmation button on the corresponding window is pressed. As described above, one of the following choices is registered in each field within the focus control and confirmation control columns: taking no action (None); displaying a character string option near the corresponding input field (Suggest); and automatically correcting the character string in the corresponding input field (AutoCorrect).

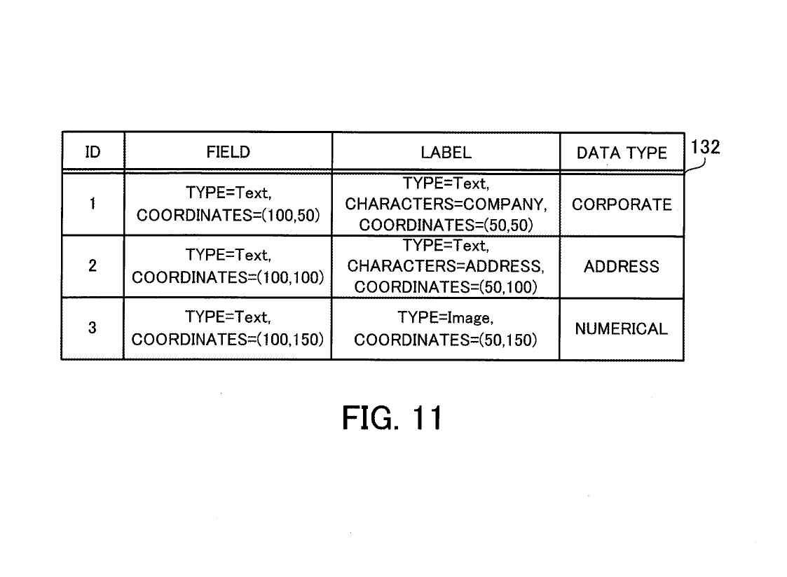

FIG. 11 illustrates an example of an input item table. An input item table 132 is stored in the control information storing unit 130. The input item table 132 is updated by the input control unit 120 through communication with the server 200. The input item table 132 includes columns of identification (ID), field, label, and data type.

Each field in the identification column contains the identifier to identify an input field. Each field in the field column contains the type and coordinates of the corresponding input field. The type of an input field in which a character string is entered in a free form is “text”. Each field in the label column contains the label type of the corresponding input field, the characters provided as a label, and the coordinates. The label type is either text or an image. In the case where the label is represented by an image, the characters may not be known. Each field in the data type column contains the data type of a character string to be entered in the corresponding input field.

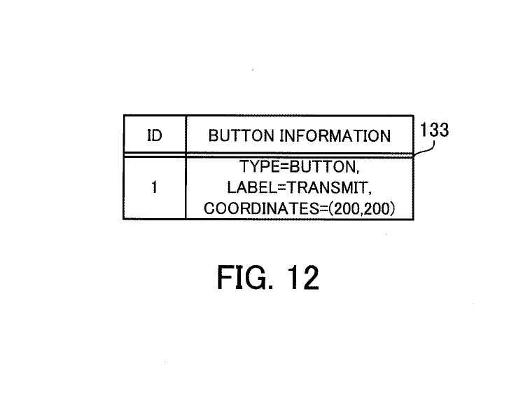

FIG. 12 illustrates an example of a confirmation button table. A confirmation button table 133 is stored in the control information storing unit 130. The confirmation button table 133 is updated by the input control unit 120 through communication with the server 200. The confirmation button table 133 includes columns of identification (ID) and button information. Each field in the identification column contains the identifier to identify a confirmation button displayed on a window. Each field in the button information column contains the display part type being “button”, the label provided for the confirmation button, and the coordinates of the confirmation button.

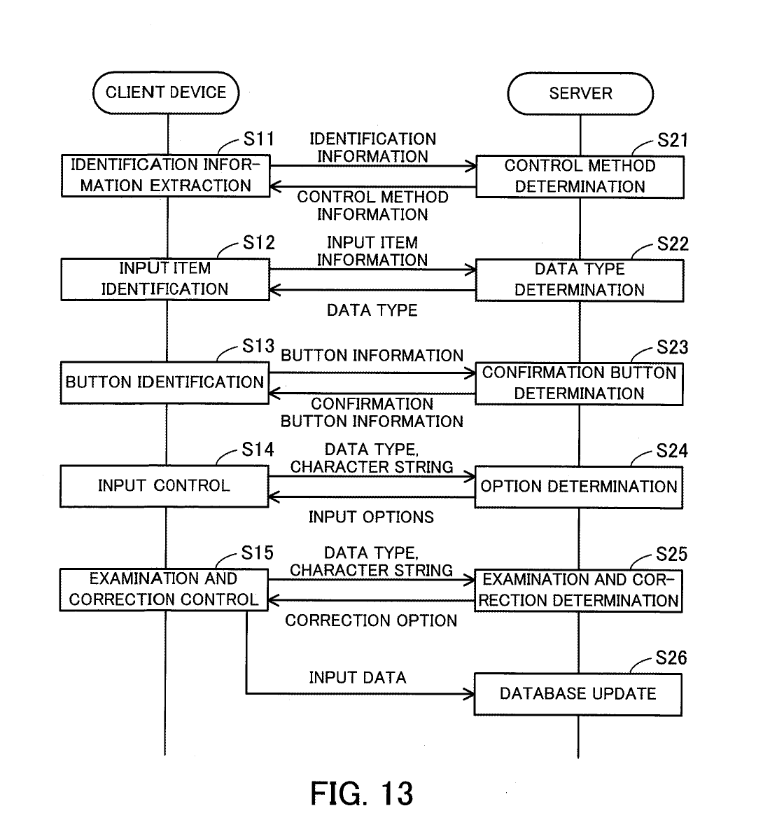

Next described is input control exercised by the client device 100 and the server 200 in cooperation with each other. Similar control is also exercised between the client device 100a and the server 200. FIG. 13 is a sequence diagram illustrating an example of communication between a client device and a server. When a window is displayed on the display 41, the client device 100 transmits identification information including a process name and a window name to the server 200 (step S11). The server 200 determines the type of input control to be exercised on the window indicated by the received identification information, and transmits control method information to the client device 100 (step S21).

The client device 100 identifies each input field included in the window, and transmits input item information including an item name and coordinates of the input field to the server 200 (step S12). The item name is represented by either text or an image. The server 200 determines the data type of a character string to be entered in the input field based on the received input item information, and returns the determined data type to the client device 100 (step S22).

The client device 100 identifies one or more buttons included in the window, and transmits button information including button names and coordinates of the buttons to the server 200 (step S13). Each of the button names is represented by either text or an image. The server 200 determines which button is a confirmation button, based on the received button information, and transmits confirmation button information indicating the determined confirmation button to the client device 100 (step S23).

The client device 100 detects that the focus has been shifted to an input field (“focus-in”) and character input has been started, or that a conversion command for an entered character string has been input. Then, the client device 100 transmits, to the server 200, the data type of the input field determined in step S22 and a character string entered up to this point in time (step S14). The server 200 converts the received character string into one or more character string options to be entered by referring to a dictionary corresponding to the informed data type, and transmits the character string options to the client device 100 (step S24). The client device 100 displays the received character string options near the input field.

The client device 100 detects that the focus has been shifted away from the input field (“focus-away”) into which a character string has been entered, or that the confirmation button has been pressed. Then, the client device 100 transmits, to the server 200, the data type of the input field and a character string entered in the input field (step S15). The server 200 calls a cleansing function corresponding to the informed data type and examines whether the received character string complies with a predetermined notation. If the character string fails the examination, the server 200 obtains a corrected character string option. Subsequently, the server 200 transmits the examination result, and the corrected character string option when the character string has failed the examination, to the client device 100 (step S25). The client device 100 displays the received character string option near, or in, the input field.

In the case where character strings of all the input fields included in the window have passed the examinations, the client device 100 determines the character strings as input data to be stored in the database and transmits the data to the server 200. The server 200 transmits the received data to the database server 32 to thereby update the database (step S26).

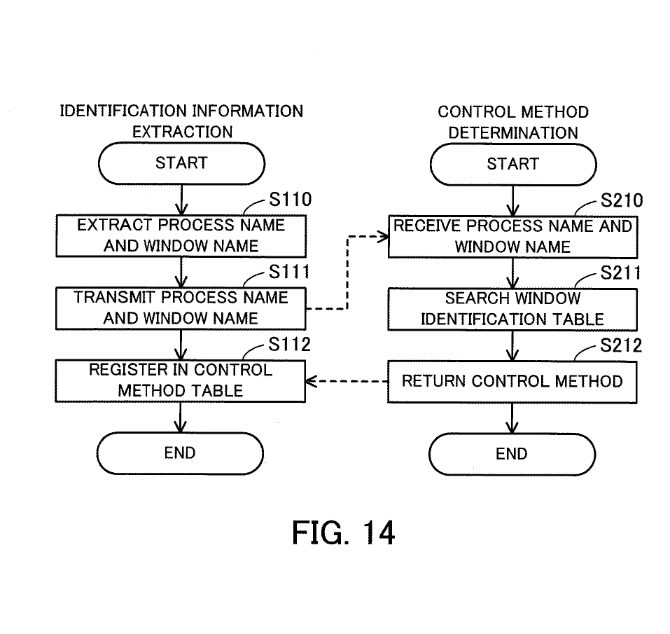

The following gives a detailed description of steps S11 to S15 and S21 to S25 above. FIG. 14 is a flowchart illustrating an example of procedures for identification information extraction and control method determination. The following steps S110 to S112 take place in step S11 described above.

(Step S110) When a window (a Web page in the case of a Web browser) is displayed by the window display unit 110, the input control unit 120 extracts a process name and a window name (a Web page name in the case of a Web browser) of the window. The process name and the window name are acquired, for example, using an API of the operation system. The Web page name is extracted, for example, from an HTML document held by the Web browser.

(Step S111) The input control unit 120 transmits identification information including the process name and the window name extracted in step S111 to the server 200.

(Step S112) The input control unit 120 receives control method information from the server 200 and registers, in the control method table 131, the control method information together with the process name and the window name extracted in step S110. The received control method information includes the control flag (FEP), the focus control method (FocusOut), and the confirmation control method (Submit).

The following steps S210 to S212 take place in step S12 described above.

(Step S210) The client supporting unit 240 receives the identification information including the process name and the window name, transmitted by the client device 100 in step S110.

(Step S211) The client supporting unit 240 searches the window identification table 251 for control method information corresponding to a pair of the process name and the window name.

(Step S212) The client supporting unit 240 transmits the control method information found by the search in step S211 to the client device 100. As described above, the control method information includes the control flag, the focus control method, and the confirmation control method. Each of the focus control method and the confirmation control method is one of the following choices: taking no action (None); displaying a character string option near the corresponding input field (Suggest); and automatically correcting the character string in the corresponding input field (AutoCorrect).

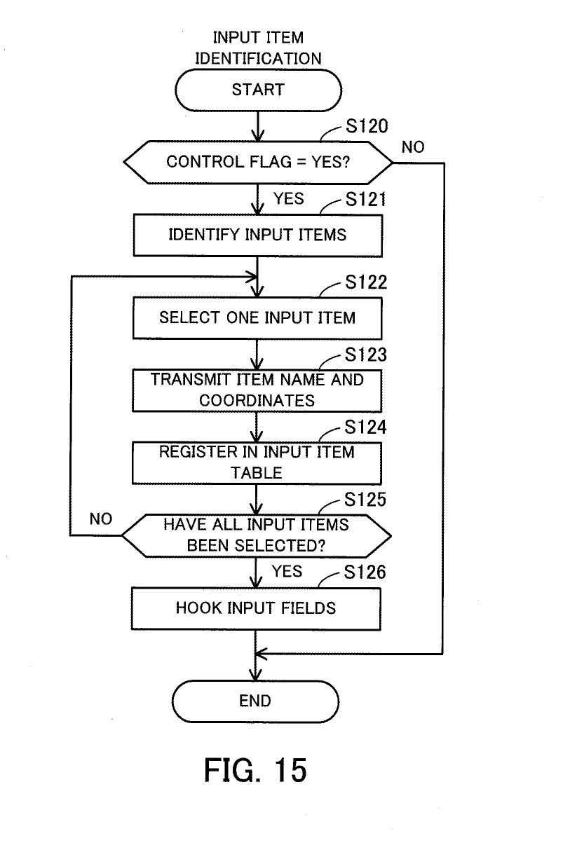

FIG. 15 is a flowchart illustrating an example of procedures for input item identification. The processing of FIG. 15 is executed by the client device 100 in step S12 above.

(Step S120) The input control unit 120 determines whether the control flag registered in the control method table 131 is set to YES (i.e., whether the window is a target for input support). If the control flag is set to YES, the processing proceeds to step S121. If not, the processing ends.

(Step S121) The input control unit 120 identifies one or more input items included in the window. For example, using an API of the operating system, the input control unit 120 searches display parts, which are subelements of the window, for input fields into each of which a character string is to be entered, and looks for a label corresponding to each of the input fields (the label is located, for example, to the left of, or above, the input field). In the case where the process is a Web browser, for example, the input control unit 120 searches an HTML document held by the Web browser for tags indicating input fields and identifies the identification name (name attribute) of each of the tags.

(Step S122) The input control unit 120 selects one of the one or more input items identified in step S121.

(Step S123) The input control unit 120 transmits input item information, including an item name of the input item selected in step S122 and its input field coordinates, together with the identification information (the process name and the window name) to the server 200. In the case where text has been extracted from a corresponding label or HTML tag, the text is transmitted as the item name. In the case where no text has been extracted, an image capturing a corresponding label is transmitted as the item name.

(Step S124) The input control unit 120 is notified by the server 200 of a data type of the input item selected in step S122. Subsequently, the input control unit 120 registers, in the input item table 132, the data type together with the information of the input item identified in step S121.

(Step S125) The input control unit 120 determines whether all the input items included in the window have been selected in step S122. If all the input items have been selected, the input control unit 120 proceeds the processing to step S126. On the other hand, if an unselected input item is still left, the input control unit 120 proceeds the processing to step S122.

(Step S126) The input control unit 120 hooks the input fields registered in the input item table 132. That is, the input control unit 120 causes event notification to be transmitted from the window display unit 110 when a user operation (focus-in or focus-away) is made for each of the input fields. Note however that, when “None” is set in a corresponding field within the focus control column of the control method table 131, a focus-away operation may not be hooked.

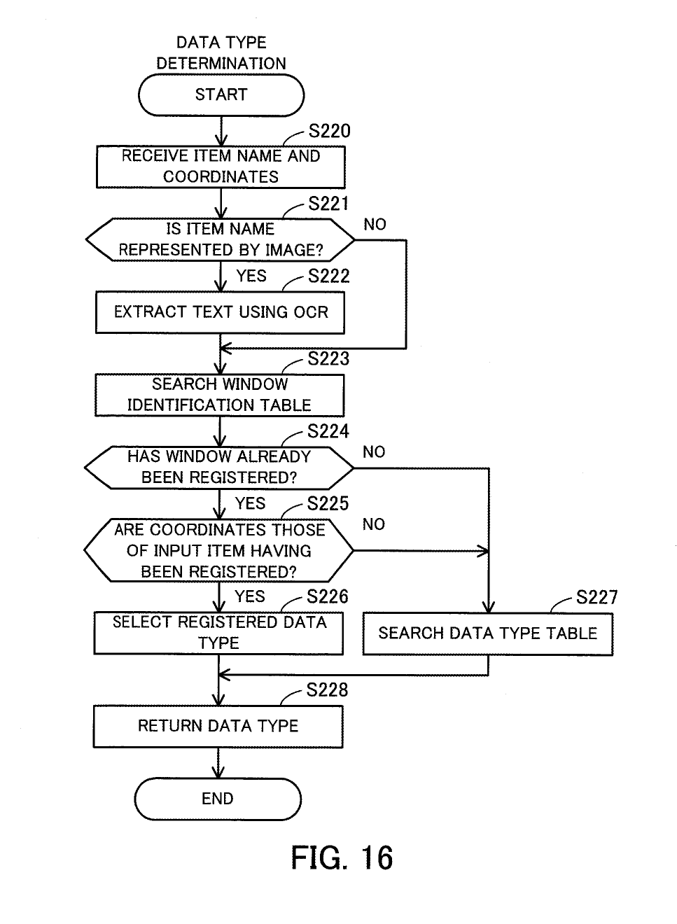

FIG. 16 is a flowchart illustrating an example of procedures for data type determination. The processing of FIG. 16 is executed by the server 200 in step S22 above.

(Step S220) The client supporting unit 240 receives, from the client device 100, the input item information including the item name and the coordinates as well as the identification information including the process name and the window name. As described above, the item name is represented by text or an image.

(Step S221) The client supporting unit 240 determines whether the item name is represented by an image. If the item name is represented by an image, the client supporting unit 240 proceeds the processing to step S222. On the other hand, if the item name is represented by text, the client supporting unit 240 proceeds the processing to step S223.

(Step S222) Using an OCR, the client supporting unit 240 extracts text (text of the label) from the image corresponding to the item name.

(Step S223) The client supporting unit 240 searches the window identification table 251 for a window indicated by the received identification information and input items of the window.

(Step S224) The client supporting unit 240 determines whether the window indicated by the received identification information has been registered in the window identification table 251. If the window has been registered, the client supporting unit 240 proceeds the processing to step S225. If not, the client supporting unit 240 proceeds the processing to step S227.

(Step S225) The client supporting unit 240 determines whether the coordinates of one of the input items found in step S223 match those indicated by the input item information. If there is a match, the client supporting unit 240 proceeds the processing to step S226. If not, the client supporting unit 240 proceeds the processing to step S227.

(Step S226) The client supporting unit 240 selects the data type of the input item whose coordinates are determined to match those indicated by the input item information in step S225, and then proceeds the processing to step S228.

(Step S227) The client supporting unit 240 searches the data type table 252 for the data type corresponding to the text of the item name included in the received input item information or the text of the item name extracted in step S222. In the case where no text for the item name has been registered in the data type table 252, the “character string” type is selected.

(Step S228) The client supporting unit 240 returns the data type selected in step S226 or S227 to the client device 100.

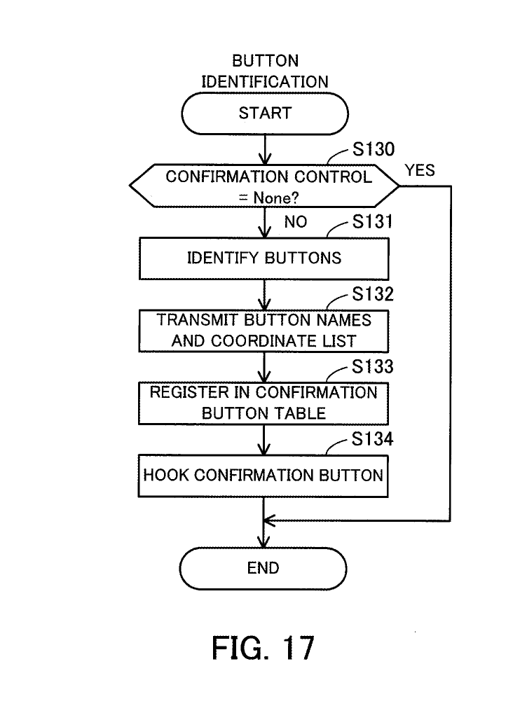

FIG. 17 is a flowchart illustrating an example of procedures for button identification. The processing of FIG. 17 is executed by the client device 100 in step S13 above.

(Step S130) The input control unit 120 determines whether, in the control method table 131, “None” (i.e., no action is taken when the confirmation button is pressed) has been registered in a corresponding field within the confirmation control column. If “None” is set for the confirmation control, the input control unit 120 ends the processing. If not (i.e., “Suggest” or “AutoCorrect” is set for the confirmation control), the input control unit 120 proceeds the processing to step S131.

(Step S131) The input control unit 120 identifies buttons included in the window. For example, using an API of the operating system, the input control unit 120 searches display parts, which are subelements of the window, for buttons. In the case where the process is a Web browser, for example, the input control unit 120 searches an HTML document held by the Web browser for tags indicating buttons.

(Step S132) The input control unit 120 transmits, to the server 200, button information including button names of all the buttons identified in step S131 and a list of coordinates of the buttons, together with the identification information (the process name and the window name). In the case where text has been extracted from a display part corresponding to each button, the text is transmitted as the button name of the button. In the case where no text has been extracted from the display part, an image capturing the button is transmitted as the button name.

(Step S133) The input control unit 120 is notified by the server 200 of a button determined as a confirmation button. Identification of the confirmation button amongst a plurality of buttons is made, for example, by its coordinates. Then, the input control unit 120 registers, in the confirmation button table 133, information of the confirmation button amongst the buttons identified in step S131.

(Step S134) The input control unit 120 hooks the button registered in the confirmation button table 133. That is, the input control unit 120 causes event notification to be transmitted from the window display unit 110 when the confirmation button is pressed.

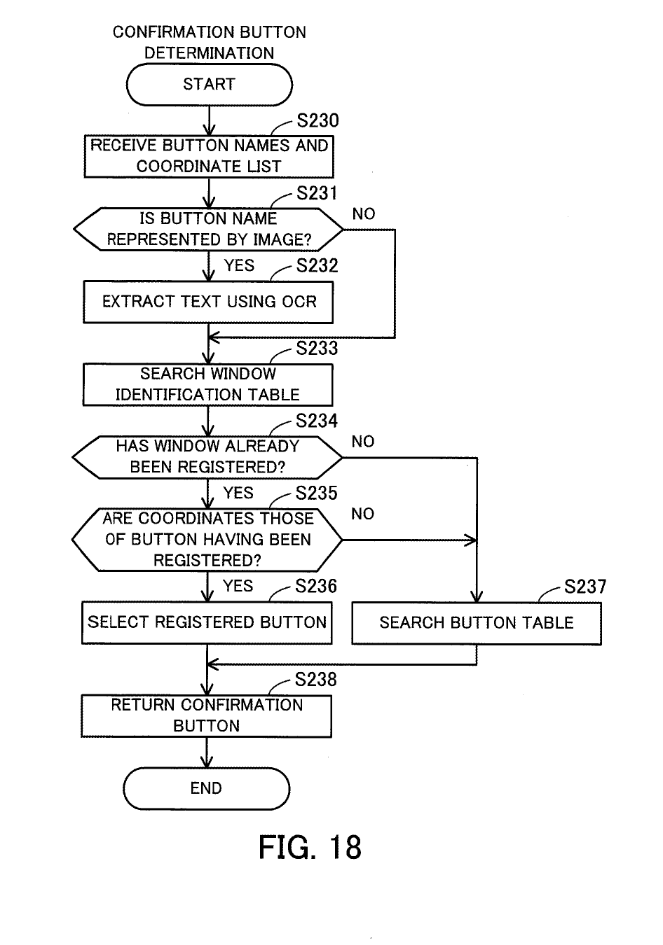

FIG. 18 is a flowchart illustrating an example of procedures for confirmation button determination. The processing of FIG. 18 is executed by the server 200 in step S23 above.

(Step S230) The client supporting unit 240 receives, from the client device 100, the button information including the button names and the coordinate list and the identification information including the process name and the window name. As described above, each of the button names is represented by text or an image.

(Step S231) The client supporting unit 240 determines whether at least one of the button names is represented by an image. If at least one of the button names is represented by an image, the client supporting unit 240 proceeds the processing to step S232. On the other hand, all the button names are represented by text, the client supporting unit 240 proceeds the processing to step S233.

(Step S232) Using an OCR, the client supporting unit 240 extracts text (text of the label part of the button) from the image corresponding to the button name.

(Step S233) The client supporting unit 240 searches the window identification table 251 for a window indicated by the received identification information and coordinates of a button included in the window.

(Step S234) The client supporting unit 240 determines whether the window indicated by the received identification information has been registered in the window identification table 251. If the window has been registered, the client supporting unit 240 proceeds the processing to step S235. If not, the client supporting unit 240 proceeds the processing to step S237.

(Step S235) The client supporting unit 240 determines whether the coordinates found by the search in step S233 match those of one of the buttons indicated by the button information. If there is a match, the client supporting unit 240 proceeds the processing to step S236. If not, the client supporting unit 240 proceeds the processing to step S237.

(Step S236) The client supporting unit 240 selects the button whose coordinates are determined, in step S235, to match those registered in the window identification table 251 as a confirmation button amongst the buttons indicated by the received button information. Then, the client supporting unit 240 proceeds the processing to step S238.

(Step S237) The client supporting unit 240 searches the button table 253 for text of each of the button names included in the received button information or text of each of the button names extracted in step S232. Then, the client supporting unit 240 selects, from the buttons indicated by the button information, a button having a button name whose control flag is set to YES in the button table 253 as a confirmation button. Note here that no confirmation button is determined to be included in the window if none of the button names indicated by the button information has been registered in the button table 253, or if the control flags of all the button names indicated by the button information are set to NO.

(Step S238) The client supporting unit 240 returns the confirmation button selected in step S236 or S237 to the client device 100. Note however that, in the case where no confirmation button is selected in step S237, the client supporting unit 240 notifies the client device 100 of a confirmation button being absent from the window. In this case, the client device 100 hooks none of the buttons included in the window.

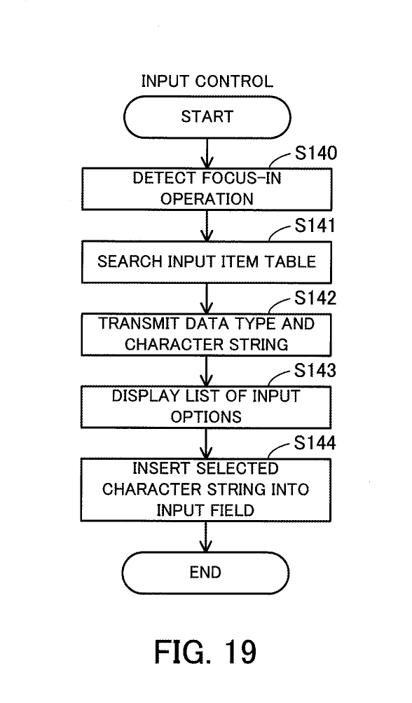

FIG. 19 is a flowchart illustrating an example of procedures for input control. The processing of FIG. 19 is executed by the client device 100 in step S14 above.

(Step S140) Based on event notification issued by the window display unit 110, the input control unit 120 detects a focus-in operation made to an input field.

(Step S141) The input control unit 120 searches the input item table 132 for a data type corresponding to the input field for which the focus-in operation has been detected, that is, a data type of a character string to be entered in the input field.

(Step S142) The input control unit 120 transmits a character string (in the case of inputting Japanese language, kana characters may be included) entered after the focus-in operation is detected, together with the data type found in step S141 to the server 200. The entered character string may be transmitted, for example, when a predetermined number (for example, three) or more of characters are entered, or when a conversion command (for example, a kana-to-kanji conversion command) for entered characters is given.

(Step S143) The input control unit 120 receives one or more character string options allowed to be entered from the server 200 and displays a list of the character string options near the input field.

(Step S144) The input control unit 120 inserts, into the input field, a character string selected by the user amongst the character string options displayed in step S143.

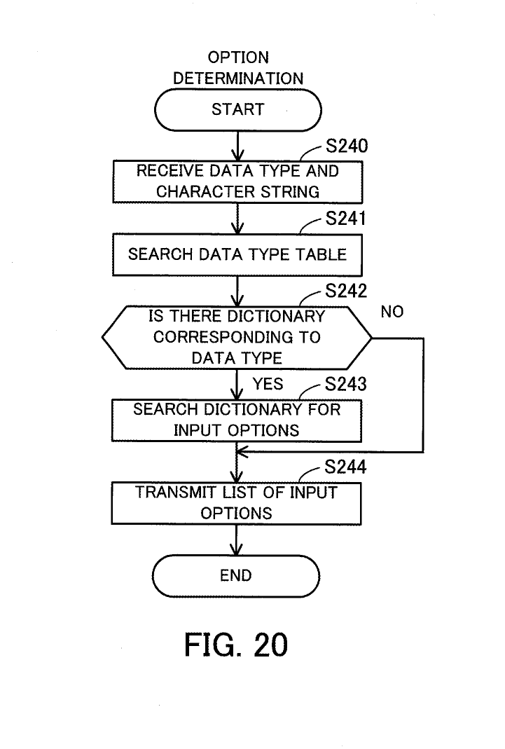

FIG. 20 is a flowchart illustrating an example of procedures for option determination. The processing of FIG. 20 is executed by the server 200 in step S24 above.

(Step S240) The client supporting unit 240 receives the data type and the character string entered up to this point in time from the client device 100.

(Step S241) The client supporting unit 240 searches the data type table 252 for a dictionary corresponding to the data type informed by the client device 100.

(Step S242) The client supporting unit 240 determines whether the dictionary has been found by the search in step S241. If the dictionary has been found, the processing proceeds to step S243. If not, the processing proceeds to step S244.

(Step S243) Referring to the dictionary found in step S241, the character converting unit 260 searches for one or more character string options in conformity with a predetermined notation (i.e., one or more character string options to be entered in the input field), corresponding to the received character string. For the search of the character string options, so-called a kana-to-kanji conversion function and a predictive conversion function may be used. For example, the character converting unit 260 selects, from a plurality of character string options listed in the dictionary, one or more character string options including received kana characters as their phonetic syllabary characters.

(Step S244) The client supporting unit 240 transmits a list of the character string options found by the search in step S243 to the client device 100. Note that in the case where no converted character string option is found, the client supporting unit 240 notifies the client device 100 of the absence of a character string option. In that case, the client device 100 just needs, for example, to display a notice about the input character string being in error.

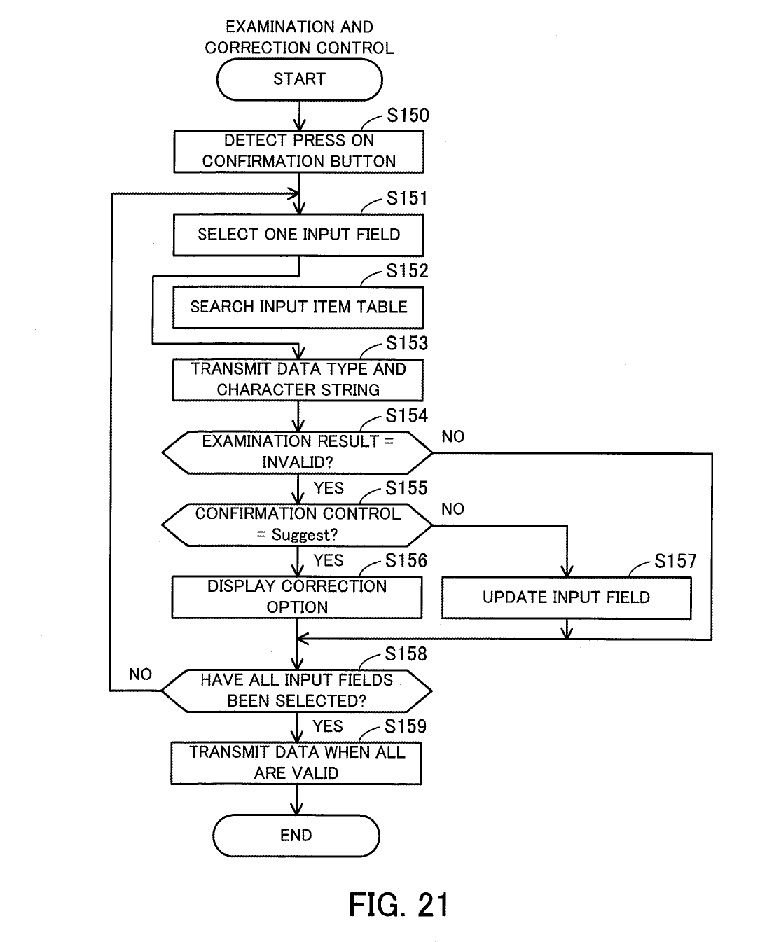

FIG. 21 is a flowchart illustrating an example of procedures for examination and correction control. The processing of FIG. 21 is executed by the client device 100 in step S15 above. The exemplified procedures for examination and correction control described here start in response to a press on a confirmation button.

(Step S150) Based on event notification issued by the window display unit 110, the input control unit 120 detects that the confirmation button has been pressed.

(Step S151) The input control unit 120 selects one input field included in a window to which the pressed confirmation button belongs.

(Step S152) The input control unit 120 searches the input item table 132 for a data type corresponding to the input field selected in step S151, that is, a data type of a character string to be entered in the input field.

(Step S153) The input control unit 120 transmits a character string entered in the selected input field to the server 200 together with the data type found in step S152.

(Step S154) The input control unit 120 receives an examination result of the character string transmitted in step S153 from the server 200 and then determines whether the received examination result is INVALID (“failed”). If the examination result is INVALID, the input control unit 120 proceeds the processing to step S155. On the other hand, if the examination result is VALID (“passed”), the input control unit 120 proceeds the processing to step S158.

(Step S155) The input control unit 120 determines whether, in the control method table 131, “Suggest” has been registered in the corresponding field within the confirmation control column. If “Suggest” is set for the confirmation control, the input control unit 120 proceeds the processing to step S156. If not (that is, when “AutoCorrect” is set), the input control unit 120 proceeds the processing to step S157.

(Step S156) The input control unit 120 displays, near the input field, a corrected character string option received together with the examination result from the server 200.

(Step S157) The input control unit 120 updates the input field using the corrected character string option. That is, the input control unit 120 replaces the current character string in the input field with the received character string.

(Step S158) The input control unit 120 determines whether all the input fields have been selected in step S151. If all the input fields have been selected, the input control unit 120 proceeds the processing to step S159. On the other hand, if an unselected input field is still left, the input control unit 120 proceeds the processing to step S151.

(Step S159) The input control unit 120 determines whether, for each of all the input fields included in the window, the examination result received from the server 200 is VALID. If the examination results are all VALID, the input control unit 120 returns the control in response to the press on the confirmation button to the window display unit 110. The window display unit 110 determines character strings currently entered in the input fields as input data, and transmits the input data to the server 200. This is a process that the window display unit 110 normally executes in response to a press on the confirmation button by the user in the case where the confirmation button is not hooked.

Note that in the examination and correction control in response to a focus-away operation, steps S152 to S157 above are executed for an input field for which the focus-away operation has been detected.

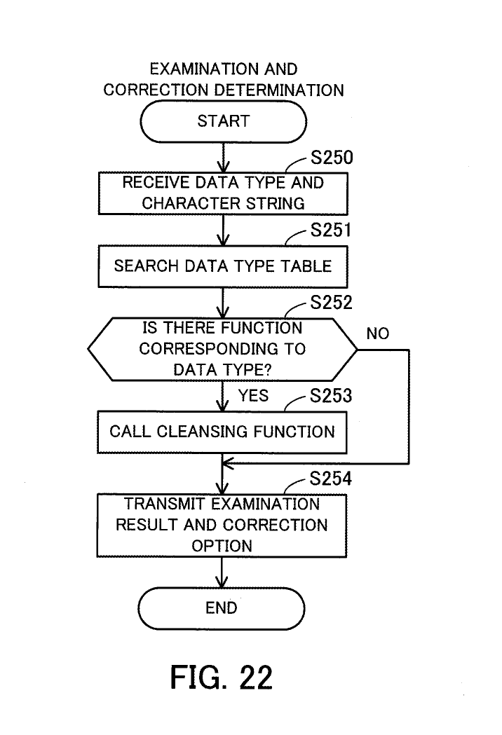

FIG. 22 is a flowchart illustrating an example of procedures for examination and correction determination. The processing of FIG. 22 is executed by the server 200 in step S25 above.

(Step S250) The client supporting unit 240 receives the data type and the character string entered in the input field from the client device 100.

(Step S251) The client supporting unit 240 searches the data type table 252 for a cleansing function corresponding to the data type informed by the client device 100.

(Step S252) The client supporting unit 240 determines whether the cleansing function has been found by the search in step S251. If the cleansing function has been found, the client supporting unit 240 proceeds the process to step S253. If not, the client supporting unit 240 proceeds the process to step S254.

(Step S253) Amongst a plurality of cleansing functions prepared in the cleansing unit 270, the client supporting unit 240 calls the cleansing function found in step S251. The cleansing unit 270 cleanses the received character string by referring to a dictionary of the data type of which the called cleansing function is in charge. That is, the cleansing unit 270 examines whether the received character string is in conformity with a predetermined notation. If determining that the character string has failed the examination (the character string does not comply with the predetermined notation), the cleansing unit 270 obtains a corrected character string option. In the cleansing function, a rule, for example, for obtaining a corrected character string from a character string before correction is defined. For example, a rule for converting an abbreviated address “12F Tokyo Bldg., 345 River St.” into a full address “Tokyo Building 12^{th} floor, 345 River Street” is defined in an address-type cleansing function.

(Step S254) The client supporting unit 240 transmits the examination result of the received character string, and the corrected character string option when the character string has failed the examination, to the client device 100. Note that in the case where no corrected character string option is found, the client supporting unit 240 notifies the client device 100 of the absence of a correction option. In that case, the client device 100 just needs, for example, to display a notice about the input character string being in error.

According to the information processing system of the second embodiment, before an entered character string is stored in the database server 32, the character string is examined to see if it complies with a predetermined, unified notation, and a corrected character string is then presented if needed. As a result, data with notation inconsistencies is prevented from being stored in the database. In addition, the server 200 determines the data type of each input field based on an item name informed by the client device 100/100a, and examines a character string entered in the input field using a dictionary corresponding to the determined data type from then on. Therefore, it is possible to easily add the input support function to the information processing system without the need, for example, for modifying definitions of existing windows or altering a program corresponding to the data processing unit 220 of the server 200a.

Note that the functions of the first embodiment are implemented by causing the terminal 10 and the management apparatus 20 to execute a program. In addition, the functions of the second embodiment are implemented by causing the client devices 100 and 100a and the servers 200 and 200a to execute a program. The program may be recorded in a computer-readable storage medium (for example, the storage medium 43). Examples of such a computer-readable recording medium include a magnetic disk, an optical disk, a magneto-optical disk, and a semiconductor memory. Examples of the magnetic disk are a flexible disk (FD) and a HDD. Examples of the optical disk are a compact disc (CD), a CD-recordable (CD-R), a CD-rewritable (CD-RW), a DVD, a DVD-R, and a DVD-RW. The program may be recorded on portable recording media for distribution. In that case, the program may be copied (installed) from a portable recording medium to another recording medium, for example, the HDD 103, and then executed.

According to one aspect, it is possible to prevent inconsistent data from being stored in a database.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An input support method executed by a system including a terminal provided with a display unit, and a management apparatus accessible from the terminal, the input support method comprising:
transmitting, from the terminal to the management apparatus, item information indicating an item name of an input field displayed on the display unit;
selecting, by a processor, a dictionary corresponding to the item information received by the management apparatus amongst a plurality of dictionaries each including a plurality of data options and classified based on a predetermined condition; and
transmitting, from the management apparatus to the terminal, at least one data option corresponding to the item information, obtained based on the selected dictionary.

2. The input support method according to claim 1, further comprising:
detecting an input operation into the input field and transmitting input data corresponding to the input operation from the terminal to the management apparatus; and
selecting, by the processor, one or more data options allowed to be entered into the input field in place of the input data received by the management apparatus amongst the data options included in the selected dictionary.

3. The input support method according to claim 2, wherein
the input operation includes at least one of a character input, an input of a conversion command for an entered character, and a focus shift from the input field to a different input field displayed on the display unit.

4. The input support method according to claim 1, further comprising:
detecting a selection operation on a display part displayed on the display unit, which display part is used to confirm input data entered into the input field, and transmitting the input data from the terminal to the management apparatus in response to the selection operation; and
selecting, by the processor, one or more data options allowed to be entered into the input field in place of the input data received by the management apparatus amongst the data options included in the selected dictionary.

5. The input support method according to claim 1, further comprising:
determining, by the processor, a data type of the input field based on the item information received by the management apparatus by referring to data type information indicating a correspondence between item names and data types,
wherein the selecting includes selecting a dictionary corresponding to the determined data type amongst the dictionaries.

6. The input support method according to claim 1, further comprising:
determining one of the data options received by the terminal as input data of the input field; and
transmitting the determined input data as data to be registered in a database from the terminal to the management apparatus or a different management apparatus.

7. An information processing system comprising:
a terminal including a display unit and a transmitter configured to transmit item information indicating an item name of an input field displayed on the display unit; and
a management apparatus including memory for storing a plurality of dictionaries each including a plurality of data options and classified based on a predetermined condition, and configured to select, amongst the dictionaries, a dictionary corresponding to the item information received from the terminal and transmit, to the terminal, at least one data option corresponding to the item information, obtained based on the selected dictionary.

8. A non-transitory computer-readable storage medium storing a computer program which causes a computer accessible from a terminal to perform a procedure comprising:
receiving, from the terminal, item information indicating an item name of an input field displayed on a display unit of the terminal;
selecting a dictionary corresponding to the received item information amongst a plurality of dictionaries each including a plurality of data options and classified based on a predetermined condition; and
transmitting, to the terminal, at least one data option corresponding to the item information, obtained based on the selected dictionary.
